(19) United States
(12) Patent Application Publication
(10) Pub. No.: US 2008/0288621 A1
(43) Pub. Date: Nov. 20, 2008

(54) AGENT WORKFLOW SYSTEM AND METHOD

(76) Inventors: Dustin M. Snell, Tujunga, CA (US); Scott B. Robinet, Van Nuys, CA (US); Joseph B. Kosco, La Canada, CA (US)

Correspondence Address: CHAN LAW GROUP LC, 1055 W. 7TH ST,, SUITE 1880, LOS ANGELES, CA, 90017, US

(21) Appl. No.: 11/750,859

(22) Filed: May 18, 2007

(51) Int. Cl. G06F 15/173

(52) U.S. Cl. 709/223; 715/765

(57) ABSTRACT

A system and method is provided for defining, executing, and managing network workflow. One or more agents execute on one or more devices in the network. A set of instructions is capable of being evaluated and executed on one or more agents. A workflow manager is for selecting which agents evaluate and execute subsets of the instructions. A workflow management document is for storing instructions created using the workflow manager, wherein at least part of the document defines the selection of the agents. One or more servers store the workflow management document and communicates with, and sends instructions to, each of the one or more agents.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

A system and method for automating network and computer processes is disclosed. More specifically, a system and method automates, adds intelligence to, orchestrates, and sequences, the execution of tasks across multiple agents installed on devices on the network.

### BACKGROUND OF THE INVENTION

Companies in the field of automation have typically focused on automating tasks on a single computer. While these tasks can often read data from other sources such as database servers or networked files, they essentially automate the computational processes occurring on one computer. These automated processes increase productivity but are very limited, especially for larger organizations that rely on networks of computers to process large amounts of information.

Other companies have focused on job scheduling which has its limitations as well. Job schedulers often rely on pre-scheduled dates/times to initiate jobs on multiple networked computers. This approach does not make automation responsive to or even aware of the network, system, and application events that continuously affect computing resources. As automation is typically dependent on and responsive to these events, job schedulers are often woefully inadequate with regard to multiple-machine, process automation. Moreover, jobs are typically written in files (scripts, batch files, or custom programs), copies of which can reside on multiple computers. This makes centralizing and managing automated processing impossible. Finally, job schedulers are often inadequate because they cannot parcel out processing across machines, or make conditional decisions about processing on one machine dependent on the resultant processing from an upstream machine.

A third area of industry focus has been on workflow software, which typically, is designed to streamline business processes involving significant human interaction such as insurance claim processing. As such, workflow software only automates the processes of organizing and transferring tasks and responsibilities from one department/individual to another department/individual. Consequently, workflow software reduces process delays and lags, but does not significantly reduce the manual effort that this type of business process demands. Additionally, workflow software does not alter its behavior as a result of the system, network, and application events that transpire across the network.

Accordingly, there is a need for a system and method that solves the problems of prior and current systems. The novel system described herein solves these and other problems by providing a system and method for managing network workflow.

### SUMMARY OF THE INVENTION

According to one preferred embodiment of the invention, a system and method for managing network workflow is provided: One or more agents execute on one or more devices in the network. One or more workflow objects each comprise a set of instructions capable of executing on the one or more agents. A workflow manager selects which agents execute selected workflow objects. A workflow management document stores workflow management data saved by the workflow manger, wherein at least part of the workflow management document defines the selection of the agents.

According to another preferred embodiment, the workflow manager comprises a graphical user interface in which one or more icons are placed, with each icon representing a workflow object. An agent selector is associated with each icon for selecting one or more of the agents to execute the workflow object represented by the icon.

According to another preferred embodiment, N number of the workflow objects comprise task objects, N being an integer>=0. Each task object represents a series of actions executed sequentially.

According to another preferred embodiment, each object is developed on a graphical user interface by dragging icons representing the various actions into a desired sequence of execution steps.

According to another preferred embodiment, N number of the workflow objects comprise conditional logic objects, N being an integer>=0. In one embodiment, the conditional logic objects comprise binary conditions determined by evaluating expressions. In another embodiment, the conditional logic objects comprise case conditions, each representing two or more conditional branches wherein an expression is evaluated to determine which branch the workflow follows. In another embodiment, the conditional logic object is for evaluation of a condition of an agent. In another embodiment, the conditional logic object is for evaluation of a condition of a network device. In another embodiment, the conditional logic object evaluates a condition immediately. In another embodiment, the conditional logic object waits for the condition to be true. In another embodiment, the conditional logic object waits for a defined period of time for the condition to be true, after which the condition is determined to be false. In another embodiment, the conditional logic object ignores a preexisting true condition. In yet another embodiment, the conditional logic object contains logic in which a condition must be met N times before the condition is true, N being an integer>0.

In another preferred embodiment, N number of the workflow objects comprise event objects, N being an integer>=0. In one embodiment, one or more of the event objects detect system events on the network.

In another preferred embodiment, N number of the workflow objects comprise conditional branch objects, each linking two other workflow objects, N being an integer>=0. In one embodiment, the conditional branch objects define paths the workflow traverses from a first workflow object to a second workflow object. In another embodiment, a success branch object defines a path of workflow when a preceding workflow object executes without error, and a failure branch object defines a path of workflow when a preceding workflow object generates an error. In yet another embodiment, an answer branch object associated with one or more values represent a criterion that, when met, determines a path of workflow path after a preceding workflow object executes.

In another preferred embodiment, N number of the workflow objects comprises time span objects, each linking two or more other workflow objects, N being an integer>=0. In one embodiment the linked workflow objects must all execute successfully during a defined time span for the associated time span workflow object to execute successfully.

In another preferred embodiment, N number of the workflow objects comprise exclusion objects, each linking one or more other workflow objects, wherein the exclusion objects comprising calendar rules that prohibit execution of linked workflow objects that do not meet the calendar rules, N being an integer>=0.

In another preferred embodiment, the workflow management document is an XML document, or a database file.

In another preferred embodiment, a system and method is provided for defining, executing, and managing network workflow. One or more agents execute on one or more devices in the network. A set of instructions is capable of being evaluated and executed on one or more agents. A workflow manager is for selecting which agents evaluate and execute subsets of the instructions. A workflow management document is for storing instructions created using the workflow manager, wherein at least part of the document defines the selection of the agents. A server stores the workflow management document and communicates with, and sends instructions to, each of the one or more agents

Another preferred embodiment provides a system and method for defining a workflow. In graphical user interface, one or more icons are placed, wherein each icon is for defining workflow objects. One or more agents are capable of executing one or more of the workflow objects. An agent selector associated with each icon is for selecting one of the agents for executing the associated workflow objects. In one embodiment, the selector comprises a drop-down list.

In one preferred embodiment, the one or more branch indicators define process flow between two or more of the icons placed in the graphical user interface. In one embodiment, a branch indicator comprises a line drawn between the two icons to define workflow path between the two icons. In one embodiment a plurality of branch indicators have variable colors to indicate one or more types of branches in the process flow. In another embodiment, at least one of the branch indicators is dashed to indicate another type of branch in the process flow.

In one preferred embodiment, one of the icons comprises a decision icon to define conditional logic. In one embodiment, the conditional logic defines a multidimensional logic decision tree. In one embodiment, the nodes of the decision tree comprise an indefinite wait condition, a time-out condition, an ignore preexisting condition and wait for next condition change, or an initiate-on-condition-met condition N times, N being an integer>0. In yet another embodiment, the conditional logic provides an answer to an expression.

In another preferred embodiment, a plain-language editor is used for defining tasks with respect to one or more of the icons placed on the graphical user interface. The plain-language editor contains a palette of icons that can be dragged and dropped to define a sequence of executions steps.

### BRIEF DESCRIPTION OF THE DRAWINGS

The described system and method is illustrated in the figures of the accompanying drawings which are meant to be exemplary and not limiting, in which like references are intended to refer to like or corresponding parts, and in which:

FIG. 1 is a block diagram illustrating components for a system and method for automating processes across multiple-machine, cross-platform networks in a workflow according to one embodiment;

FIG. 2 is a block diagram that illustrates a basic network structure of this embodiment;

FIG. 3 is a screen shot of an exemplary menu screen for a workflow manager interface;

FIG. 4 is a screen shot of an exemplary process graphical user interface for defining workflows according to one embodiment;

FIG. 5 is a flow diagram that illustrates data flow according to another embodiment in which N number of the workflow objects comprise time span objects;

FIG. 6 is a flow diagram that illustrates data flow according to another embodiment in which N number of the workflow objects comprise exclusion objects;

FIG. 7 is an exemplary condition definition screen for defining a conditional workflow object according to one embodiment;

FIG. 8 is a flow diagram that illustrates steps performed for executing a build process according to one embodiment;

FIG. 9 is a screen shot of a plain language editor according to one embodiment; and

FIG. 10 is a screen shot of a prompt that appears on a user's screen upon selection of an action icon appearing in the screen shot of FIG. 8.

### DETAILED DESCRIPTION OF THE PREFERRED EMBODIMENTS

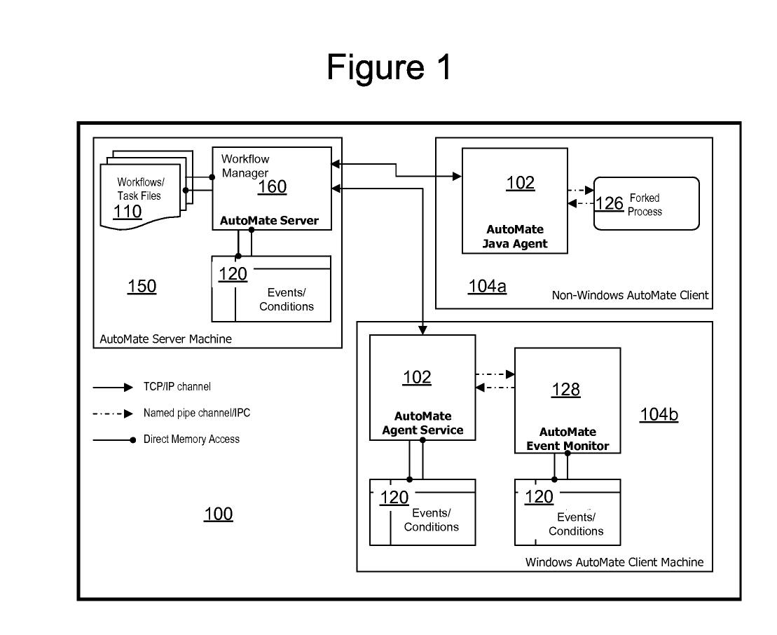

With reference to FIG. 1, in one embodiment, a system and method for automating processes across multiple-machine, cross-platform networks in a workflow is disclosed. Workflows reside as workflow management data in workflow management files 110 on a server 150. A workflow manager 160 communicates with agent-based devices 104a, 104b, or machines, in the network 100. An agent 102 is an installation of software capable of communicating with the workflow manager 160 and server 150, and is capable of executing instructions (in the form of a task, condition, event, or flow control object) passed to it by the server 150 at execution time.

In one embodiment, an agent 102 is registered with the workflow manager before usage. This is done during the installation of the agent 102 or on first execution of the agent 102. The agent 102 attempts to connect to the server 150 at an address specified during installation. The server 150 attempts to find the agent's identification in a secure agent database that is maintained by the server 150. If the identification cannot be found, the server reports this to the agent 102. In one embodiment, the agent 102 then attempts to register with the server 150 using a valid registration account. If the registration account information is validated, the agent 102 is registered automatically, the server makes a new agent registration entry in the agent database, and allows the agent 102 to connect to the workflow manager 102. Otherwise, the request is denied.

In one embodiment, the workflow manager 160 is responsible for managing a workflow database, users and user groups, registered agents 102, agent clusters, and any server-side events/conditions 120, such as a scheduler. The server 150 communicates system and interactive events/conditions to the appropriate agents 102, and handles events/conditions from those agents 120 when they transpire. The server 150 then executes the associated workflows, dispatching workflow objects to the appropriate agents 120 for processing and managing relevant error-handling.

In one embodiment, the workflow manager 160 maintains a database of agent groups and their associated agents 102. Agent groups can be added, removed and modified. Groups can be attached to a workflow object to specify what agent or agents 102 the workflow object shall execute on.

In one embodiment, the groups have associated properties that affect the behavior of the agents 102 in the group. For example, in one embodiment, the property of “allowable states” specifies which workflow states can execute on the agents 102 in the group. By default, the agent 102 can run all states. Otherwise, only those states listed in the agent group can execute a workflow of that state. For example, if the agent group is set for “production,” then only those workflows in a “production” state can execute on that agent.

As another example, in one embodiment, the property of “clustering” specifies whether all or specific agents are to run a workflow object, and under what circumstances. In a round-robin cluster, each subsequent run of the workflow object executes on the next agent 102 in the group. In a fail-over cluster, the system attempts run the workflow object on a first agent 102 in the group. If the workflow object fails, the system attempts the next agent 102 in the group, and so on, until the workflow object executes successfully or there are no more agents 102 to try. In a simultaneous group, the workflow object runs on all agents 102 in the group.

In one embodiment, each clustering option includes a “CPU Threshold”, whereby a central processing unit (CPU) reading with respect to an agent 102 greater than a specified threshold results in a failure of the agent 102.

In one embodiment, the responsibility of running through the process of a workflow lies with the server 150. The workflow manager 160 on the server 150 parses the workflow and executes the appropriate workflow objects as necessary. Because, in this embodiment, the server is responsible for execution, any workflow object can run on any connected agent 102. This allows for full network automation because events/conditions 120, tasks and processes can be distributed across the network 100, and workflow execution can be dependant upon results of one or more agents 102.

In one embodiment, multi-threading enhances the performance of the workflow manager 160 by allowing the main thread to handle what it can while processor intensive tasks are marshaled to other threads. On multi-processor machines, threads can even be handled by a completely separate processor as seen fit by the operating system's processor scheduler.

In one embodiment, server-side events/conditions 120 that require polling, or events/conditions 120 that have the potential of hanging for whatever reason, are segregated to a separate thread in order to minimize interference with the server's main thread, which is primarily responsible for communicating with the operating system and handling connection requests from agents 102. Workflow execution is preferably handled by a separate thread in order to allow the workflow manager 160 to execute more than one task at a time. TCP/IP communication is handled by separate threads, as blocking sockets or communication interruptions could otherwise cause the main thread to hang and cause workflow stoppage. Further logging is also preferably handled in a separate thread as excessive file or database writing under a heavy processing load could cause the workflow manager 160 to become unresponsive.

In one embodiment, the events/conditions 120 are divided into three main categories: server-side, system and interactive. Sever-side events/conditions 120 are objects that run and are completely managed by the workflow manger 160. These events/conditions respond to events that are either specific to the sever 150 as a system, or require synchronization between agents 102 that cannot be achieved by the agents 102 themselves. An example of such a event/condition 120 is a schedule watcher. Scheduled events are monitored and maintained by the server 150 for all the agents 102 in the system. Otherwise, agents 102 could be initiated at different times depending on the local system's clocks (if they are not completely synchronized with the server 150). Also, events/conditions 120 writing back their last execution time and attempting to reschedule themselves could cause infinite loops if clocks are not synchronized. In such a case, it is appropriate for the server 150 to take full responsibility for the events/condition 120 to keep all agents 102 synchronized.

System events/conditions 120 are those that run on the agent 102 through an agent service. These events/conditions 120 have the ability to respond to, or detect, events specific to the system and do not require interaction from the user. Such events/conditions include a Windows® event log condition, file watcher condition, and any others that can operate in the context of LocalSystem on the service. System event/conditions 120 are available regardless of whether or not a workstation is logged on.

Interactive event/conditions 120 are those that are run through an agent event monitor to trap events that are generated by interactive user events. Some of these include, for example, without limitation, a window condition or hotkey event.

In one embodiment, special agents 102 called enterprise agents 102 are primarily responsible for accepting event/condition configurations from the server 150, and responding to events when they occur. In one embodiment, the regular agent 102 is required to communicate a event/condition configuration to an enterprise agent event monitor if one or more interactive event/conditions are in use. The agents 102 report back to the server 150, though they may also send back system information to the server 150, such as whether or not the host device 104 is logged on.

Different agents 102 can be installed on different devices 104a, 104b depending on the device's operating system. For example, one for devices 104a, 104b can use an agent 102 that runs on a device 104a using the Microsoft Windows® operating system environment, and another agent 102 will install on any Java-enabled device 104b, including a device 104b that uses Linux, Unix, Macintosh, or the like, as an operating system.

In some embodiments, there may be minor differences in the way a Windows®-operating agent 102 and a non-Windows®-operating agent 102 executes. In one embodiment, non-Windows®-based agents 120 are simply light-weight communication engines that accept commands from the server 150 to launch spawned or forked processes 126 and report back a return code. This provides functionality on these systems as means to execute scripts and non-Windows® automation processes on a wide range of systems.

In embodiment, a process graphical user interface (shown and described below) is used as a primary interface to the workflow manger 160. It allows configuration of the workflow manger 160, and construction and management of workflows.

In one embodiment, an event monitor 128 is configured as a separate process to monitor device or network events/conditions 120, while in other embodiments, the agent 102 itself monitors the events/conditions 120. In one embodiment, a server-side event/condition 120 is an event/condition 120 that is hosted and managed by the workflow manager 160. This type of event/condition 120 is useful for certain types of events/conditions 120, such as one that depends on a scheduler.

A job scheduling and event-based event engine 120 detects various events transpiring on a device 104a, 104b, over the network 100, or in an application, and initiates workflows that contain events/conditions with specified criteria that match those of the event. Examples include scheduled events, such, for example, an event initiating a workflow every weekday at 8:10 AM, and the presence of a text file in excess of 1 GB in a specified directory. In one embodiment, there are tens, hundreds, thousands, or any number of different events that could initiate a workflow.

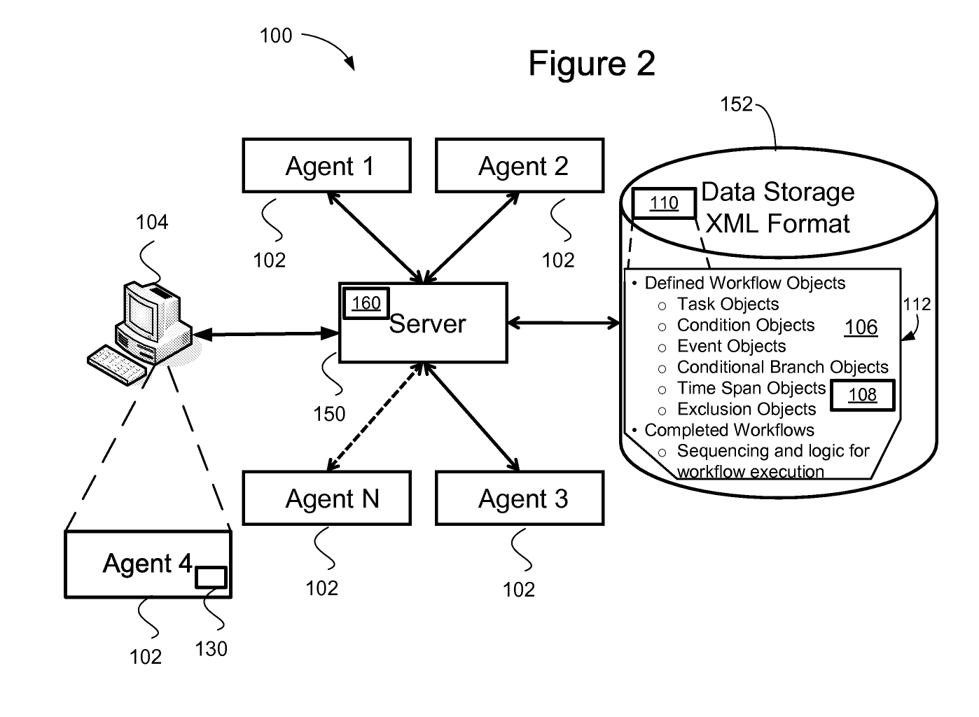

With reference to FIG. 2, a block diagram illustrates a basic network structure 100 of a system and method for managing network workflow according to one embodiment. One or more agents 102 execute on one or more devices 104 in the network 100. One device 104 in FIG. 2 is illustrated as a personal computer-type device 104 with an agent 102 executing in memory. However, it should be understood that the a device 104 could be any device 104 capable of attaching to a network, including, but not limited to, notebook computers, servers, networked personal digital assistants (PDA), network cellular telephones, printers, and the like. For example, some high-end household appliances are now network capable, and can be used as a device 104 in the network 100. In this way, workflows can be written to detect, for example, that a refrigerator door is opened, and a workflow object could be initiated to sound an alarm to protect children who may have refrigerator items fall on them, or the like.

A server 150 is connected to the network 100, having or connected to a server storage device 152, such as a hard disk. In one embodiment, the server 150 contains information regarding current workflow configuration, a change history file for the workflows, statistics on workflow performance and execution, reporting capabilities, notification parameters, and the like.

In one embodiment, the agent 102 runs as a service. It detects events/conditions and communicates with the server 150. It tells the server 150 that an event/condition has been detected, and the server 150 provides the agent 102 with instructions for execution of other workflow objects such as tasks, conditions, events, and flow controls. The agent 102 receives these instructions, interprets them, and executes them while providing the server 150 with information regarding the progress, status, and completion of the instructions.

One or more workflow objects 106 each comprise a set of instructions 108 capable of executing on the one or more agents 102. A workflow manager 160 selects which agents 102 execute selected workflow objects 106. It should be noted that, while the workflow manager 160 is shown executing on the server 150 in FIG. 2, in another embodiment, the workflow manager 160 executes on a network device 104 instead. A workflow management file or document 110 stores workflow management data 112 saved by the workflow manger 160, wherein at least part of the workflow management document 110 defines the selection of the agents 102. In one embodiment, the workflow management document 110 is an XML document. In another embodiment, the workflow management document 110 is a database file.

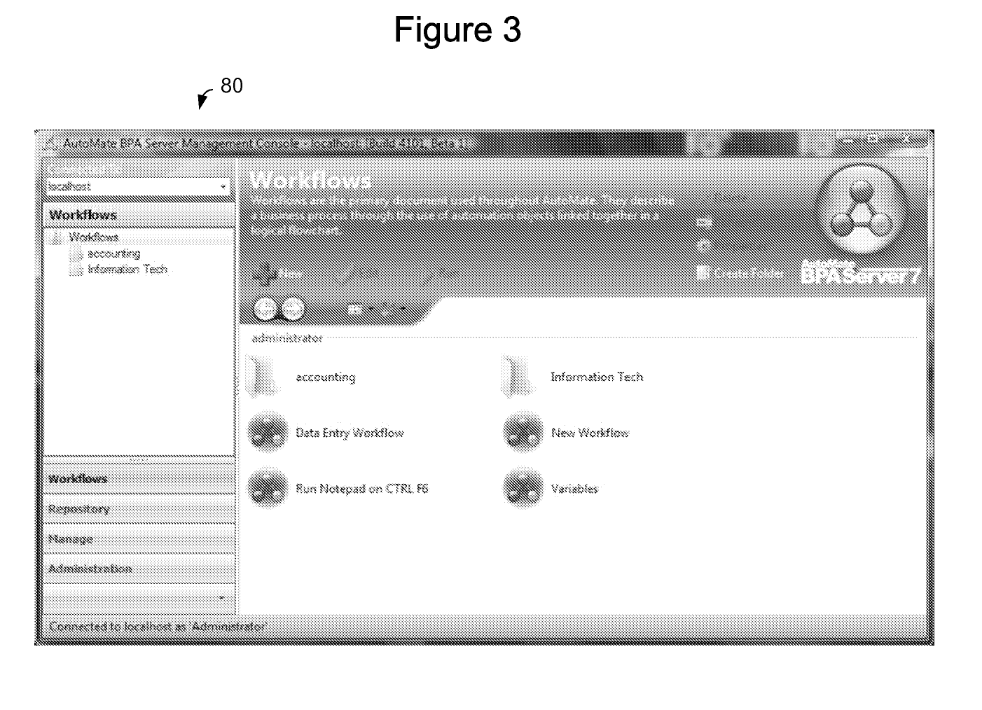

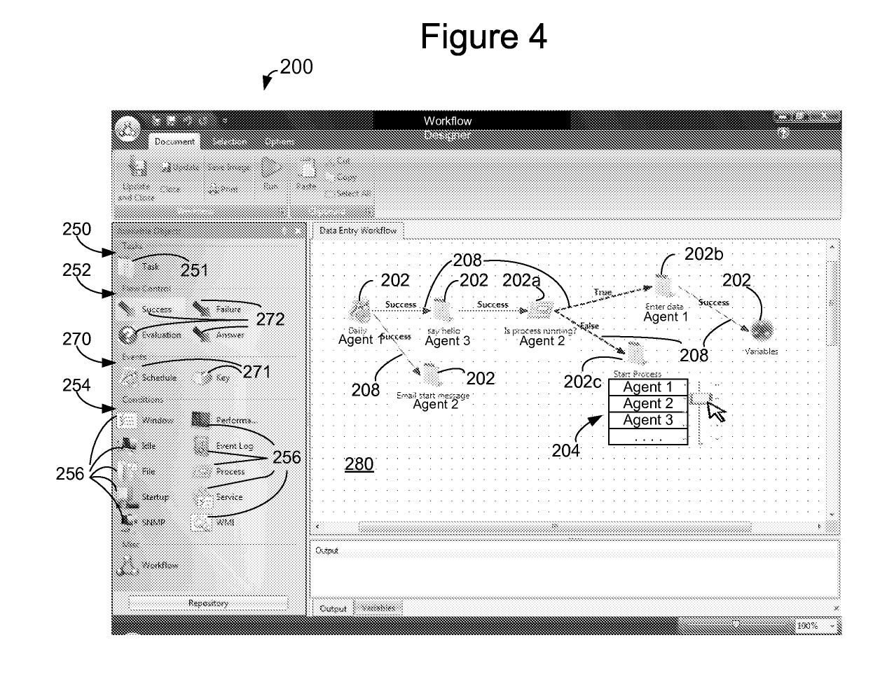

With reference to FIG. 3, a screen shot of a workflow manager tool interface screen 80 is shown in accord with one embodiment. As part of the work flow manager 160, the manger tool interface screen 80 serves as an opening screen to access various administrative and programming tools. From this screen, among many options, the user can select “New Workflow” or “Data Entry Workflow” to create or edit a workflow respectively. Once a new or existing workflow is selected, a process graphical user interface screen according to that described with respect to FIG. 4 below is displayed in accord with one embodiment.

According to one embodiment, each workflow object 106 is developed on a process graphical user interface by dragging icons representing the various workflow objects 106 into a desired sequence and logical relationships in the workflow. In this embodiment, at least part of the workflow manager 160 comprises a graphical user interface in which one or more icons are placed, with each icon representing a workflow object 106. With reference to FIG. 4, a screen shot of an exemplary process graphical user interface (process GUI) 200 according to one embodiment is shown. The process GUI 200 is a development interface that contains the tools necessary for development, configuration, and ongoing management/administration of the workflows, tasks, conditions, events, flow controls, and the like. The process GUI 200 contains a process definition area 280 wherein processes for the agents (102 in FIG. 2) are defined. An agent selector 204 is associated with each icon 202 for selecting one or more of the agents (102 in FIG. 2) to execute the workflow object represented by the icon 202. In the embodiment of FIG. 4, the selector 204 comprises a drop-down selection list that displays agents 102 registered in the system and available to complete tasks. However, it should be understood that, as those skilled in the art would recognize, that there are many ways that the workflow manager 160 may select agents to complete a task, including, but not limited to: dynamic selection, intelligent selection, conditional selection, and the like.

In one embodiment, the user may define logic on the process GUI 200 by the placement of the icons 202 and branch indicators, or lines, in the graphical user interface. For example, in FIG. 4, icon 202a is a conditional logic icon selected from the “Conditions” section 254 of available icons of on the process GUI 200. The user can define a condition associated with the workflow object 106 represented by a conditional logic icon 202a to create a conditional logic object. The conditional workflow object defines conditional branches to determine which workflow path is followed: either to the workflow object 106 defined by icon 202b or that defined by icon 202c. In one embodiment, N number of the workflow objects 106 comprise conditional logic objects, N being an integer>=0. In one embodiment, the conditional logic objects comprise binary conditions determined by evaluating expressions. In another embodiment, the conditional logic objects comprise case conditions, each representing two or more conditional branches wherein an expression is evaluated to determine which branch the workflow follows. In another embodiment, the conditional logic object is for evaluation of a condition of an agent 102. In another embodiment, the conditional logic object is for evaluation of a condition of a network device. For example, the conditional logic object can check if a printer is on-line. In another embodiment, the conditional logic object evaluates a condition immediately. In another embodiment, the conditional logic object waits for the condition to be true. In another embodiment, the conditional logic object waits for a defined period of time for the condition to be true, after which the condition is determined to be false. In another embodiment, the conditional logic object ignores a preexisting true condition. In yet another embodiment, the conditional logic object contains logic in which a condition must be met N times before the condition is true, N being an integer>0.

Similarly, in one embodiment, N number of the workflow objects 106 comprise one or more task objects, N being an integer>=0. Each task object represents a series of actions executed sequentially. In the embodiment of FIG. 4, a task object is defined by dragging and dropping a task icon 251 from the task icon selection area 250 of the process GUI 200 onto the process definition area 280. As discussed below, a task definition screen appears if the task icon that has been placed in the process GUI 280 is opened, usually by double clicking the task icon.

In one embodiment, N number of the workflow objects 106 comprise event objects, N being an integer>=0. In one embodiment, the event objects detect system events on the network 100. An event object is defined in the embodiment of FIG. 4 by dragging and dropping an event icon 271 from an event icon selection area 270 of the process GUI 200 onto the process definition area 280.

In one embodiment, N number of the workflow objects 106 comprise condition objects, N being an integer>=0. In one embodiment, the condition objects detect system events on the network 100. An event object is defined in the embodiment of FIG. 4 by dragging and dropping a condition icon 256 from a condition icon selection area 254 of the process GUI 200 onto the process definition area 280.

In another embodiment, N number of the workflow objects 106 comprise conditional branch objects, each linking two other workflow objects 106, N being an integer>=0. In one embodiment, the conditional branch objects define paths the workflow traverses from a first workflow object 106 to a second workflow object 106. In another embodiment, a success branch object defines a path of workflow when a preceding workflow object 106 executes without error, and a failure branch object defines a path of workflow when a preceding workflow object 106 generates an error. In yet another embodiment, an answer branch object associated with one or more values represent a criterion that, when met, determines a path of workflow path after a preceding workflow object 106 executes. A conditional branch object is defined in the embodiment of FIG. 4 by dragging and dropping a flow control icon 272 from the flow control icon selection area 252 of the process GUI 200 onto the process definition area 280.

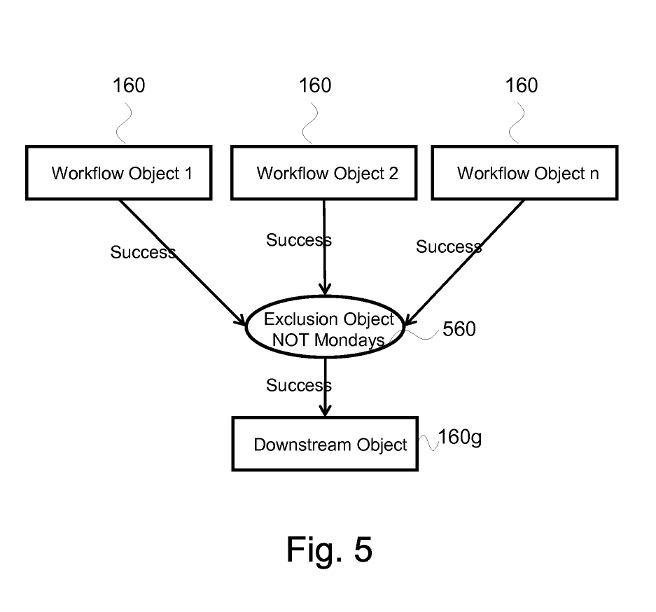

With reference to FIG. 5, a flow diagram illustrates data flow according to another embodiment in which N number of the workflow objects 106 comprise time span objects. Each work flow object 106, links two or more other workflow objects 106. In this embodiment, the linked workflow objects 106 must execute successfully during a defined time span (30 seconds in the example of FIG. 5) for the associated time span workflow object 460 to execute successfully. If successful, then the workflow moves to the next or downstream work flow object 160g.

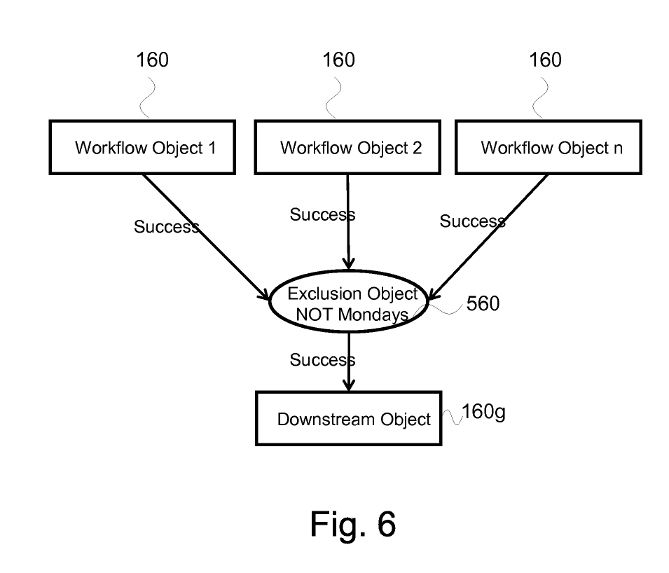

With reference to FIG. 6, a flow diagram illustrates data flow according to another embodiment in which N number of the workflow objects 106 comprise exclusion objects. By way of example only, and not by way of limitation, in the embodiment of FIG. 6, an exclusion workflow object 560 links one or more other workflow objects 106, wherein the exclusion workflow object comprises calendar rules that prohibit execution of a downstream workflow object 106g that does not meet the calendar rules. An associated exclusion workflow object 560 executes successfully if the calendar rules are met, before executing the downstream workflow object 160g. In embodiment of FIG. 6, the exclusion workflow object 560 prevents execution of the downstream workflow object 160g if the calendar day is Monday.

With reference back to FIG. 2, in another embodiment, the system and method is provided for defining, executing, and managing network workflow. The one or more agents 102 execute on one or more devices 104 in the network 100. A set of instructions 130 is capable of being evaluated and executed on one or more agents 102. The workflow manager 160 is for selecting which agents 102 evaluate and execute subsets of the instructions 130. The workflow management document 110 is for storing instructions created using the workflow manager 160, wherein at least part of the workflow management 110 document defines the selection of the agents 102. A server 150 stores the workflow management document 110 and communicates with, and sends instructions to, each of the one or more agents 102.

With reference to FIG. 4, in the embodiment illustrated therein, the one or more branch indicators 208 define process flow between two or more workflow objects 106 represented by icons 202 placed in the graphical user interface 200. In one embodiment, a branch indicator 208 comprises a line drawn between the two icons 202 to define workflow path between the two workflow objects 106 represented by the icons 202. In one embodiment a plurality of branch indicators 208 have variable colors to indicate one or more types of branches in the process flow. In another embodiment, at least one of the branch indicators 208 is dashed to indicate another type of branch in the process flow.

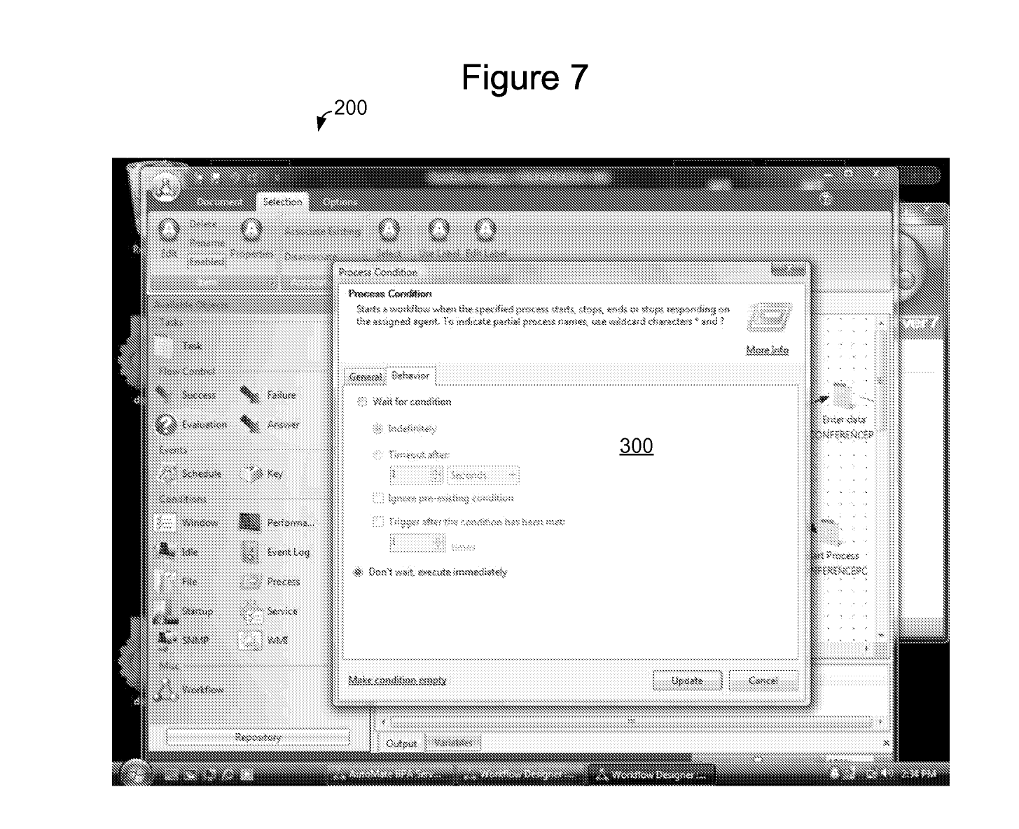

In one embodiment, one of the icons 202 comprises a decision icon to define conditional logic. For example, in FIG. 4, one such decision icon is a Process icon 256 shown as one of the Conditions icons 254. A process icon has been dragged into place as icon 202a onto the process definition area 280 in FIG. 4. With reference to FIG. 7, an exemplary condition definition screen 300 is shown. In the embodiment of FIG. 7, the process definition screen 300 appears as a layer on top of the process GUI 200. In this embodiment, when the user double clicks, or selects open with respect to, the Process icon 202a, the condition definition screen 303 appears to define conditional logic for the workflow object 106 represented by the Process icon 202a. The process definition screen 300 allows the user to define a multidimensional logic decision tree. In the embodiment of FIG. 7, the nodes of the decision tree comprise an indefinite wait condition, a time-out condition, an ignore preexisting condition and wait for next condition change, or an initiate-on-condition-met condition N times, N being an integer>0. Alternatively, the condition may be defined so that the next workflow object 106 executes immediately, or to timeout and not execute the next condition after a set period of time.

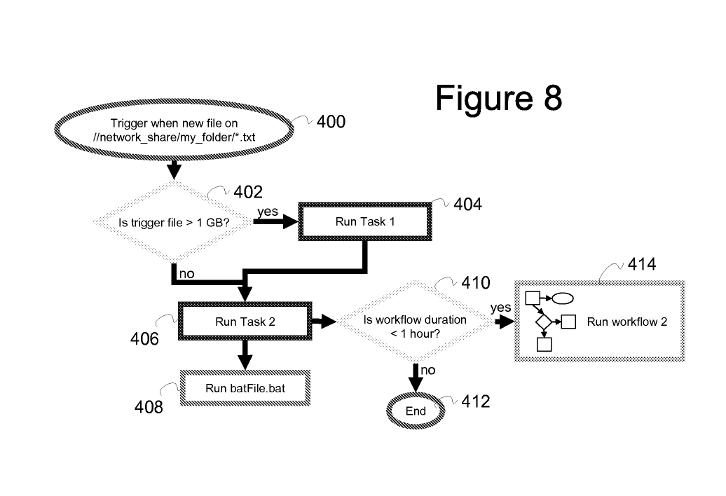

FIG. 8 is a flow diagram that illustrates steps performed executing a workflow according to one embodiment. The workflow manager 160, executing now as the workflow engine executing on the server 130, reads the workflow document 110 and executes the workflow objects 106 according the logic stored in the workflow document 110 resulting from the logic defined using the process GUI 200. In one embodiment, the workflow document data is read by the workflow manager 160 into a control workflow object. The control workflow object is a high-level object that contains all the information to automate a given business or IT process. The control workflow object, in one embodiment, communicates with the subordinate workflow objects 106, including, but not limited to, tasks, conditions, events, and flow controls, running on agents 102 on the network devices. In step 400, the workflow object is initiated on a device 204, for example, called “machine #1.” The workflow object 106 may have been initiated by an event object 271 or condition object 256. In this example, the File control object has been programmed to execute when a text file (i.e., *.txt) appears in a network shared directory called //network-share/myfolder/. Once initiated, in step 402, in this example, the workflow object 106 running on machine #1 makes a decision. The file that initiated the workflow is analyzed to determine whether it is greater than 1 gigabyte (GB) in file size. If so, in step 404, data is sent to the control workflow object, which initiates execution of a task for the agent on another network device 104, called in this example, “machine #3.” A task is a set of instructions (ranging from the very simple to the very complex) that is executed on a device 104, on which an agent 102 is executing.

If the answer to conditional logic object 402 is “no,” or after the completion of the task of block 404 on machine #3, the workflow initiates a different task on an agent 102 of another device 104. In this example, this device is called “machine #2,” step 406. When this task is complete, two processes are initiated. In step 408, for example, a file batFile.bat on machine #3 is executed, and the conditional logic object determines whether the workflow's duration (from initiation to this point in time) is less than 1 hour, step 410. If the answer is “yes”, the workflow terminates, step 412. If the answer is “no”, the workflow initiates a second workflow which may execute on another device, for example machine #4, step 414.

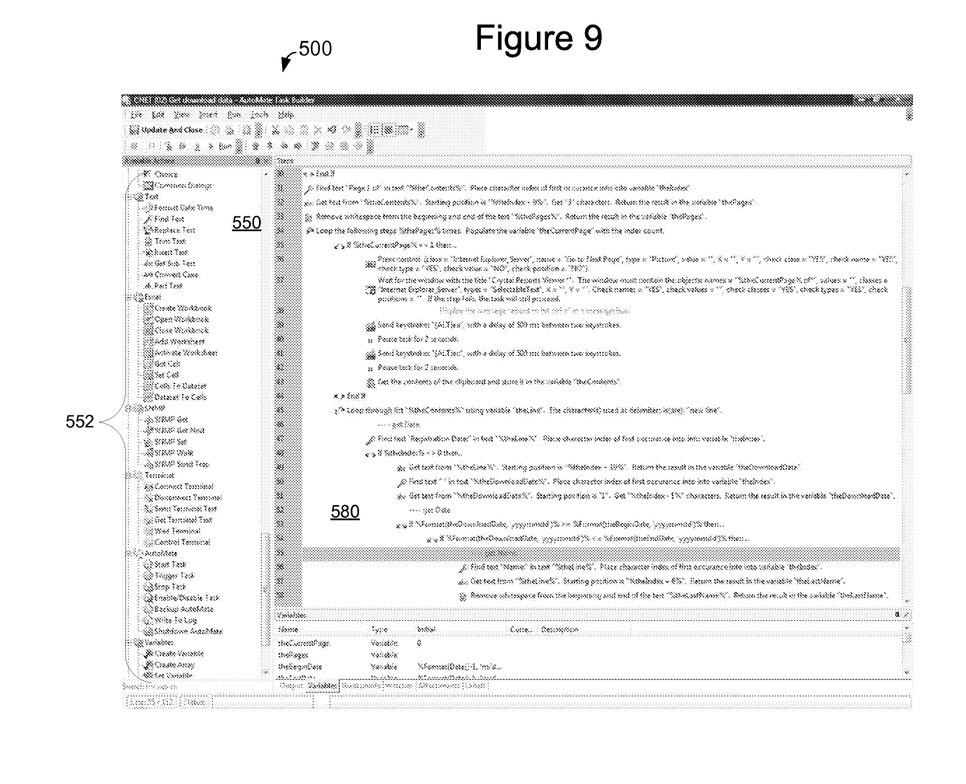

In one embodiment, a plain-language editor, or a “task builder” is used for defining tasks for the workflow object 106 represented by a task icon 202b, 202c placed in the process definition area 280 the graphical user interface 200. With reference to FIG. 9, a screen shot 500 of a plain language editor according to one embodiment is shown. The plain-language editor is a drag-and-drop, plain-language application development platform that contains a palette, or action pane 550, of step icons, or actions 552, that can be dragged and dropped to define a sequence of executions steps in a task programming area 580. The actions 550 are the tools an application developer can drag-and-drop into the Steps pane to create a task step. Double-clicking on an action produces a window allowing for plain-language configuration of the action. One preferred such plain-language editor is available, and can be purchased, from the assignee of this application, Network Automation Inc. of Los Angeles, Calif., U.S.A, and is called AUTOMATE™. In one embodiment, hundreds, thousands, or an unlimited number of available actions can be arranged and configured to automate virtually all common applications and information technology (IT) processes, without requiring developers to understand syntax and write code.

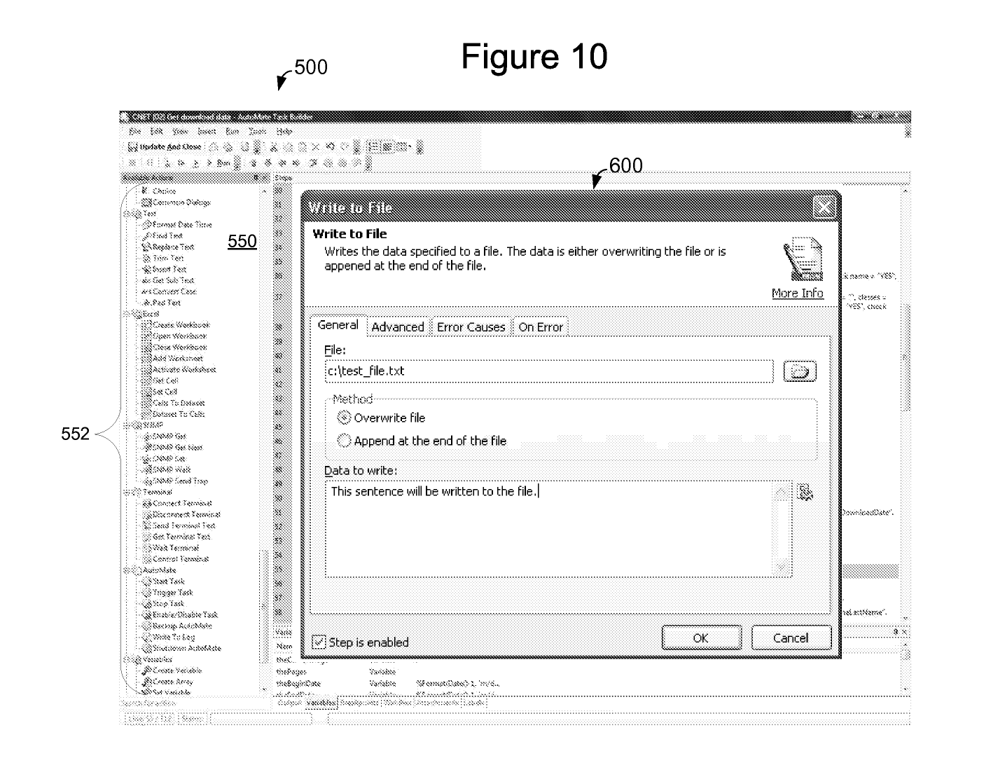

For example, in one embodiment, an available action 552 for a task is called a “Write to File” action. After double clicking on the action icon for the Write to File action, The prompt 600 shown in FIG. 10 appears on the graphical user interface 500. The prompt 600 asks the user to select the location where a new file will be created, as well as the data to place in the file. Following the logic defined using the process GUI 200 described above, the agent 102 executes the task workflow object 106 to write the file at the appropriate time.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A system for managing network workflow:
one or more agents for executing on one or more devices in the network;
one or more workflow objects each comprising a set of instructions capable of executing on the one or more agents;
a workflow manager for selecting which agents execute selected workflow objects; and
a workflow management document for storing workflow management data saved by the workflow manger, wherein at least part of the workflow management document defines the selection of the agents.

2. The system of claim 1, wherein the workflow manager comprises a graphical user interface in which one or more icons are placed, with each icon representing a workflow object.

3. The system of claim 2, wherein an agent selector is associated with each icon for selecting one or more of the agents to execute the workflow object represented by the icon.

4. The system of claim 1, wherein N number of the workflow objects comprises task objects, N being an integer>=0.

5. The system of claim 4, wherein each task object represents a series of actions executed sequentially.

6. The system of claim 4, wherein each object is developed on a graphical user interface by dragging icons representing the various actions into a desired sequence of execution steps.

7. The system of claim 1, wherein N number of the workflow objects comprises conditional logic objects, N being an integer>=0.

8. The system of claim 7, wherein the conditional logic objects comprise binary conditions determined by evaluating expressions.

9. The system of claim 7, wherein the conditional logic objects comprise case conditions, each representing two or more conditional branches wherein an expression is evaluated to determine which branch the workflow follows.

10. The system of claim 7, wherein the conditional logic object is for evaluation of a condition of an agent.

11. The system of claim 7, wherein the conditional logic object is for evaluation of a condition of a network device.

12. The system of claim 7, wherein the conditional logic object evaluates a condition immediately.

13. The system of claim 7, wherein the conditional logic object waits for the condition to be true.

14. The system of claim 7, wherein the conditional logic object waits for a defined period of time for the condition to be true, after which the condition is determined to be false.

15. The system of claim 7, wherein the conditional logic object ignores a preexisting true condition.

16. The system of claim 7, wherein the conditional logic object contains logic in which a condition must be met N times before the condition is true, N being an integer>0.

17. The system of claim 1, wherein N number of the workflow objects comprises event objects, N being an integer>=0.

18. The system of claim 17, wherein one or more of the event objects detect events on the network.

19. The system of claim 1, wherein N number of the workflow objects comprise conditional branch objects, each linking two other workflow objects, N being an integer>=0.

20. The system of claim 19, wherein the conditional branch objects define paths the workflow traverses from a first workflow object to a second workflow object.

21. The system of claim 19, comprising a success branch object defining a path of workflow when a preceding workflow object executes without error, and further comprising a failure branch object defining a path of workflow when a preceding workflow object generates an error.

22. The system of claim 19, comprising an answer branch object associated with one or more values representing a criterion that, when met, determines a path of workflow path after a preceding workflow object executes.

23. The system of claim 1, wherein N number of the workflow objects comprises time span objects, each linking two or more other workflow objects, N being an integer>=0.

24. The system of claim 23, wherein the linked workflow objects must all execute successfully during a defined time span for the associated time span workflow object to execute successfully.

25. The system of claim 1, wherein N number of the workflow objects comprises exclusion objects, each linking one or more other workflow objects, and the workflow objects comprising calendar rules that prohibit execution of linked workflow objects that do not meet the calendar rules, N being an integer>=0.

26. The system of claim 1, wherein the workflow management document is an XML document.

27. The system of claim 1, wherein the workflow management document is database file.

28. A system for defining, executing, and managing network workflow:
one or more agents for executing on one or more devices in the network;
a set of instructions capable of being evaluated and executed on one or more agents;
a workflow manager for selecting which agents evaluate and execute subsets of the instructions; and
a workflow management document for storing instructions created using the workflow manager, wherein at least part of the document defines the selection of the agents; and
one or more servers for storing the workflow management document and for communicating with, and sending instructions to, each of the one or more agents

29. A system for defining a workflow:
a graphical user interface;
one or more icons for placing in the graphical user interface, each icon for defining workflow objects;
one or more agents capable of executing one or more of the workflow objects; and
an agent selector associated with each icon for selecting one of the agents for executing the workflow objects.

30. The system of claim 19, further comprising one or more branch indicators for defining process flow between two or more of the icons placed in the graphical user interface.

31. The system of claim 30, wherein one of the branch indicators comprises a line drawn between the two icons to define workflow path between the two icons.

32. The system of claim 31, wherein one of the icons comprises a decision icon to define conditional logic.

33. The system of claim 32, wherein the conditional logic defines a multidimensional logic decision tree.

34. The system of claim 33, wherein the nodes of the decision tree are each selected from the group consisting of: an indefinite wait condition; a time-out condition; ignore preexisting condition and wait for next condition change; a initiate-on-condition-met condition N times, N being an integer>0.

35. The system of claim 29, wherein the selector comprises a drop-down list.

36. The system of claim 32 wherein the conditional logic provides an answer to an expression.

37. The system of claim 30 comprising a plurality of branch indicators, each of the branch indicators having variable colors to indicate one or more types of branches in the process flow.

38. The system of claim 30 comprising a plurality of branch indicators, at least one of the branch indicators being dashed to indicate a selected type of branch in the process flow.

39. The system of claim 29, further comprising a plain-language editor for defining tasks with respect to one or more of the icons placed on the graphical user interface.

40. The system of claim 39, wherein the plain-language editor contains a palette of icons that can be dragged and dropped to define a sequence of executions steps.

41. A method for managing network workflow:
executing a set of instructions in each of one or more workflow objects executed by each of one or more agents executing on one or more devices in the network;
selecting which agents execute selected workflow objects; and
storing workflow management data in a workflow management document, wherein at least part of the workflow management document defines the selection of the agents.

42. The method of claim 41, further comprising placing icons in a graphical user interface, with each icon representing a workflow object.

43. The method of claim 42, further comprising selecting one or more of the agents to execute the workflow object represented by the icon.

44. The method of claim 41, wherein N number of the workflow objects comprises task objects, N being an integer>=0.

45. The method of claim 44, wherein each task object represents a series of actions executed sequentially.

46. The method of claim 44, comprising developing each object on a graphical user interface by dragging icons representing the various actions into a desired sequence of execution steps.

47. The method of claim 41, wherein N number of the workflow objects comprises conditional logic objects, N being an integer>=0.

48. The method of claim 47, wherein the conditional logic objects comprise binary conditions determined by evaluating expressions.

49. The method of claim 47, wherein the conditional logic objects comprise case conditions, each representing two or more conditional branches wherein an expression is evaluated to determine which branch the workflow follows.

50. The method of claim 47, wherein the conditional logic object is for evaluation of a condition of an agent.

51. The method of claim 47, wherein the conditional logic object is for evaluation of a condition of a network device.

52. The method of claim 47, wherein the conditional logic object evaluates a condition immediately.

53. The method of claim 47, wherein the conditional logic object waits for the condition to be true.

54. The method of claim 47, wherein the conditional logic object waits for a defined period of time for the condition to be true, after which the condition is determined to be false.

55. The method of claim 47, wherein the conditional logic object ignores a preexisting true condition.

56. The method of claim 47, wherein the conditional logic object contains logic in which a condition must be met N times before the condition is true, N being an integer>0.

57. The method of claim 41, wherein N number of the workflow objects comprises event objects, N being an integer>=0.

58. The method of claim 57, wherein one or more of the event objects detect system events on the network.

59. The method of claim 41, wherein N number of the workflow objects comprise conditional branch objects, each linking two other workflow objects, N being an integer>=0.

60. The method of claim 59, wherein the conditional branch objects define paths the workflow traverses from a first workflow object to a second workflow object.

61. The method of claim 59, comprising defining a path of workflow using a success branch object for when a preceding workflow object executes without error, and further comprising defining a path of workflow using a failure branch object for when a preceding workflow object generates an error.

62. The method of claim 59, comprising representing a criterion that, when met, determines a path of workflow path after a preceding workflow object executes using an answer branch object associated with one or more values.

63. The method of claim 41, wherein N number of the workflow objects comprises time span objects, each linking two or more other workflow objects, N being an integer>=0.

64. The method of claim 63, wherein the linked workflow objects must all execute successfully during a defined time span for the associated time span workflow object to execute successfully.

65. The method of claim 41, wherein N number of the workflow objects comprises exclusion objects, each linking one or more other workflow objects, wherein the exclusion objects comprising calendar rules that prohibit execution of linked workflow objects that do not meet the calendar rules, N being an integer>=0.

66. The method of claim 41, wherein the step of storing is performed using an XML document.

67. The method of claim 41, wherein the step of storing is performed using a database file.
